(19) United States
(12) Patent Application Publication
(10) Pub. No.: US 2003/0184785 A1
(43) Pub. Date: Oct. 2, 2003

(54) System and method for printing print friendly media

(76) Inventor: Srinivas Guddanti, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/112,195

(22) Filed: Mar. 29, 2002

(51) Int. Cl. G06F 15/00; B41B 1/00

(52) U.S. Cl. 358/1.13; 358/1.6

(57) ABSTRACT

A system and method for printing print friendly media. A printer includes a display, a bar code scanner and a database of printer characteristics. Bar coded media is scanned using the bar code scanner. The database of printer characteristics is then searched for the optimum printer configuration for printing on the scanned media. The optimum configuration information is then displayed to an operator through the printer window. As an alternative, the optimum configuration information is used to automatically adjust the printer, to optimize printing on the media.

### BACKGROUND OF THE INVENTION

1. Field of the Invention

This invention relates to office automation devices. Specifically, the present invention relates to printing devices.

2. Description of the Related Art

A typical enterprise uses a variety of office automation devices. For example, a typical enterprise will utilize a number of different types of printers. The enterprise may have several different printer models made by the same manufacturer or different printer models made by different manufacturers. The enterprise may even have the same printer model made by the same manufacturer, however, the latest revision of software may change the capability of the printer, giving the printer new functionality.

With the large variety of printers used in a modern enterprise it is difficult for operating personnel to keep track of how each printer operates. As a result, taking advantage of all the printer features either becomes a laborious task or operating personnel typically decide to use a small subset of the printer features.

The large variety of printers in an enterprise creates a number of issues for operators. The quality of a print job often depends on the type of media used and the printer settings.

Given the variety of printers deployed in an enterprise, an operator may not be able to tell if the media works with the printer until several attempts are made to use the media in the printer. Further, an operator may not be able to determine the preferred media for the printer without laborious trial and error or reference to the printer manual.

Lastly, even if an operator knows an optimal setting to use on a print job, the ability to interface with most printers to change settings is extremely limited.

There is a need to enable operators to exploit the capability of different printers without extensive operator training across different printing platforms. There is a further need for a printer system that will adjust to print media and for a printing system that will optimize printing on many different types of print media, without substantial operator intervention.

### SUMMARY OF THE INVENTION

The present invention is directed to a method and apparatus for adjusting a printer to optimize printing on a print media. A printer is disclosed which includes a bar code scanner which scans bar code information, a database which stores print media characteristics and a display for interfacing between the printer and an operator. A bar code, which reflects the characteristics of the print media, is scanned into the printer by the bar code scanner. The scanned information is then used as a key to search a database for data that will either be displayed in the print window or that will be used to automatically adjust the printer settings.

In a first embodiment of the present invention, a single data element is read in from the bar code. The single data element is used as a search key to search the database for media characteristics. A number of media characteristics are then displayed in the printer window for selection by an operator.

In a second embodiment of the present invention, multiple data elements are read from the bar code. These data elements are used to search the database and identify an optimized setting for the printer. The printer is then mechanically adjusted to the optimum setting.

In accordance with an illustrative implementation of the method of the present invention, a bar code is scanned and two types of information are read in from the bar code. A database is checked for the first type of information and the second type of information. Three scenarios then result. If neither the first information nor the second information is in the database, a first message is displayed in the printer display. If both the first type of information and the second type of information are in the database then a second message is displayed in the printer display. Lastly, if either the first message or the second message is in the database then a third message is displayed in the printer display.

### BRIEF DESCRIPTION OF THE DRAWINGS

FIG. 1 is a system diagram of the present invention.

FIG. 2 is a diagram showing a conceptual view of a database used in an illustrative embodiment of the present invention.

FIG. 3 is a flow diagram of the method of the present invention.

FIG. 4 is a table of the fields stored in a database used in the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

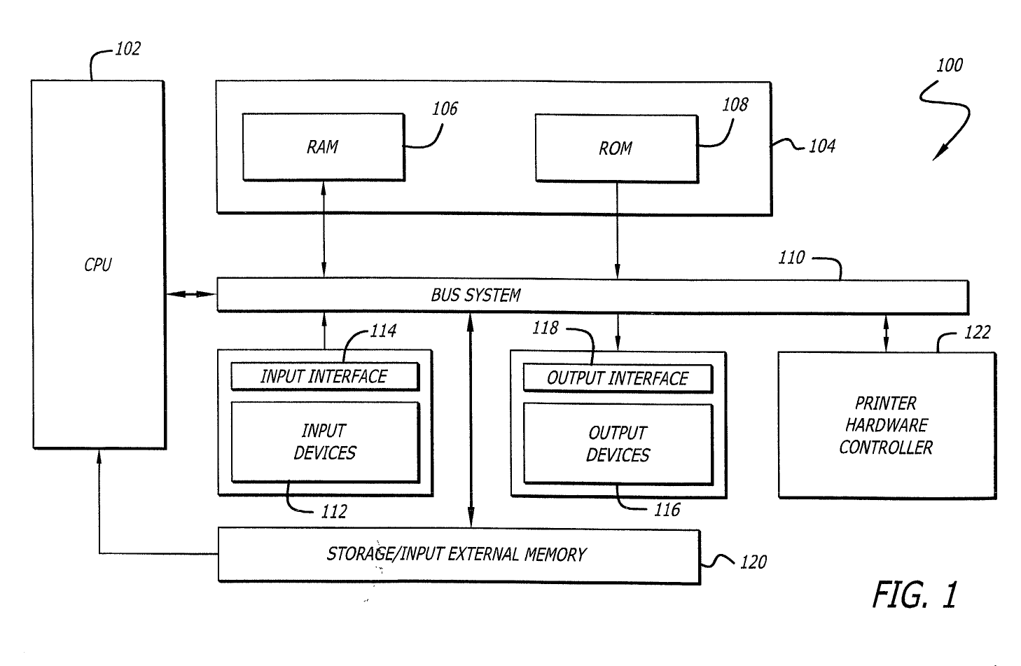

FIG. 1 is a block diagram of an illustrative embodiment of a system implemented in accordance with the teachings of the present invention. As shown in FIG. 1, the system 100 includes a central processing unit (CPU) 102. Internal memory 104 is included which provides random access memory 106 for staging information and a read only memory 108 for storing computer instructions. The CPU 102 accesses information in the RAM 106 and the ROM 108 through a standardized communication pathway or a bus 110. Input devices such as a keyboard, a mouse, a joy stick, a scanner and a light pen are also shown as 112. Communication between the input device 112 and other parts of the system, is accomplished through an input interface 114 and the bus 110. Output devices such as a monitor and a printer are also shown. Communication between an output device and other parts of the system, is accomplished through the bus 110 and an output interface 118.

In the illustrative embodiment of the present invention, a bar code scanner is the specific input device 120. The bar code scanner 120 scans information from a bar code printed on a package containing print media. The bar code includes characteristics of the print media, which are used in conjunction with the printer, to configure the printer in accordance with an optimum configuration for printing on the print media.

Output devices 116 such as a printer display window are also shown. Communication between an output device 116 and other parts of the system is accomplished through an output interface 118 and bus 110. External memory 120 (e.g. a hard drive or disk memory) is also shown. A printer hardware controller 122 provides an interface between the CPU 102 and the printer hardware. As a result, the CPU 102 is able to automatically control hardware such as the ink system, the printer roller system, the print media tray systems or any other printer hardware system.

In accordance with the present teachings, the bar code scanner scans bar code information from the packaging on the print media or an operator reads the bar code information and inputs the information through a key pad. The CPU 102 processes the bar code information by accessing computer programs stored in a ROM 108 or in external memory 120 (e.g. hard drive). Database information or computer programs are then accessed in the external memory 120. The CPU 102 then processes the computer instructions to appropriately configure the printer.

According to the methodology of the present invention, information is accessed from a bar code on the print media and input in the printer using an input device 112 (e.g. key pad or scanner). The input device 112 interfaces with the CPU 102 using the input interface 114 and the bus 110. The CPU 102 then processes the bar code information according to the computer instructions stored in the ROM 108 or in the external memory (e.g. hard drive) 120. The combination of the media characteristics and the computer instructions processed by the CPU will be used to (a) display options for the operator on an output device 110 (e.g. printer window) or (b) reconfigure the printer to an optimized configuration for printing on the media.

When printer options are to be displayed for the operator, the CPU 102 processes the computer programs stored in the internal memory 104 or in the external memory 120 and transmits printer options to the output device 110 (e.g. printer display window). When the printer is to be reconfigured, the CPU interfaces with the hardware controller 122 to control printer hardware such as the ink system, the rollers and the paper trays. During this process the CPU 102 typically accesses a database which may be stored on the external memory 120 (e.g. hard drive). The database contains optimum settings for the printer. These settings are then used to reconfigure the printer.

The bar code on the media may communicate various types of information to the printer. For example, the bar code may contain a reference number, a manufacturer designation, a media weight, or a number of other printer related characteristics such as stiffness, surface smoothness, etc. In one embodiment of the present invention, the bar code information is used to determine whether the media can be used with the printer. In a second embodiment of the present invention, the bar code information is used to optimize the printer for the specific type of media.

After the scanner scans the bar code, a search is made of a database. The database is stored in a memory in the printer. Scanner hardware may be used to read the information from the bar code scanner. In addition memory interface hardware may be used to search and access information from the database, based on the information scanned in by the bar code scanner. The memory interface hardware is also connected to other sections of the printer directly, or through the central processing unit of the printer. When the optimum printer characteristics are read from the memory, the memory interface hardware communicates the printer characteristics to the central processing unit of the printer. The central processing unit then sends instructions to hardware in various parts of the printer. The printer hardware is then adjusted accordingly.

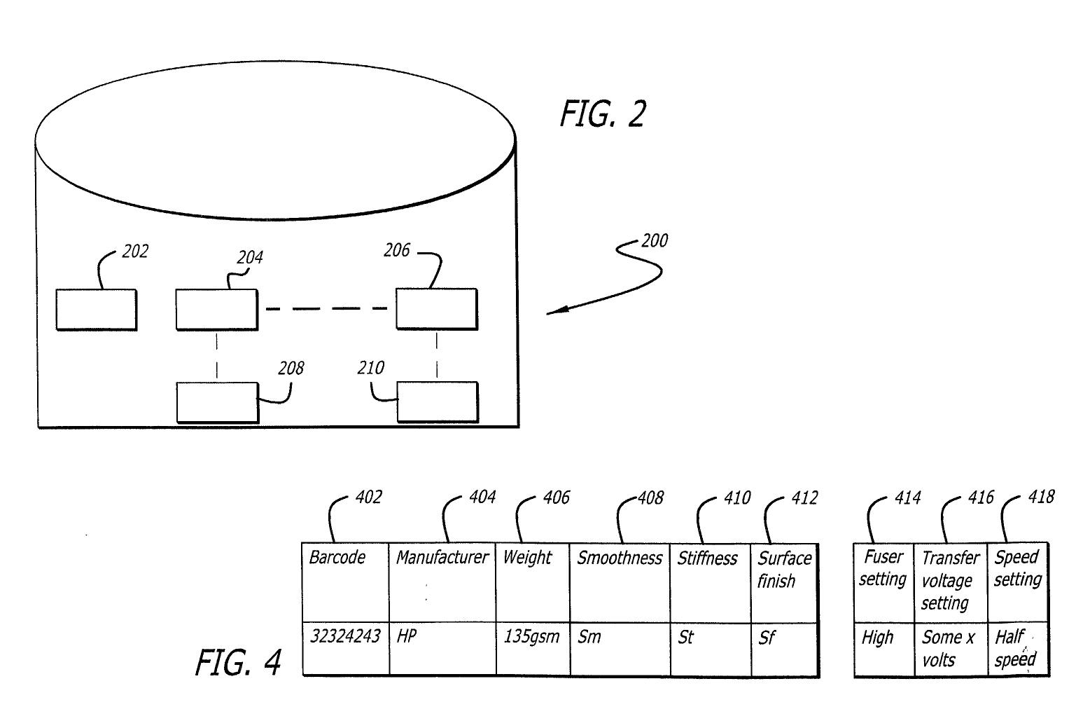

The database includes initial information that is read from the bar code by the bar code scanner. The initial information is used as a key to search the database. For example, the key may be a manufacturer or a paper type. FIG. 2 displays a conceptual drawing of the database 200. The database includes a first field or key field 202, a second field 204 and an nth field 206. The first field may be a manufacturer field, a paper type field or another type of field. The first field or the key field will be used to search the database for information corresponding to the information read from the bar code, by the bar code scanner.

In accordance with an illustrative embodiment of the method of the present invention, the bar code on the media will contain a single item of information for searching the database or multiple items of information for searching the database. With a single item of information, the database may be searched in multiple dimensions and choices may be displayed for the operator in the printer window. For example, if the single item of information or key is the manufacturer, a search may be made of multiple different types of data fields or of one type of data field for characteristics related to the manufacturer. A search of multiple types of data fields may include a search of media weights or media types.

In the alternative, in a search of a single type of data field, multiple media weights may be displayed in the printer window for selection by the operator or multiple media types may be displayed in the printer window for selection by the operator.

Using FIG. 2 as an example, if the manufacturer is signified by key field 202 then the paper weight field may be shown as 204 to 208. This might represent searching a single type of data field (e.g. paper weight) or searching the database in one direction, the vertical direction. The same may be said if the key field 202 corresponds to a paper type field 206 to 210. Fields 206 to 210 may also be considered a single type of data (e.g. paper type) and searched in one direction, the vertical direction.

In the alternative, the key field 202 can be used to search horizontally across multiple types of data such as the media weight field 204, the media type field 206 and other fields that are not shown. In this scenario, one would be performing a horizontal search. As a result of the ability to search the database in both the horizontal and vertical directions, the database may be considered a two-dimensional database. Database items may be displayed in the printer window for selection by the operator or used to automatically adjust the printer.

When the bar code contains multiple items of data, these multiple items of data become keys that can be used to search the database. For example, if the manufacturer and media weight are the two items of data, the manufacturer field may be searched first and then the media weight may be searched. After these items are found in the database, statements may be displayed in the printer window indicating the suitability of the media for use in the printer.

In addition, to displaying a message regarding the suitability of the media for that printer, the input media characteristics are used to look up the printer settings to be used to print the media, thereby obtaining the best performance on that particular media.

As an alternative, a link may be made to a routine which includes the optimum settings for the media. The routine may then make adjustments to the printer hardware such as the flow of ink, the belt speed or the printer roller spacing, based on the settings read from the database.

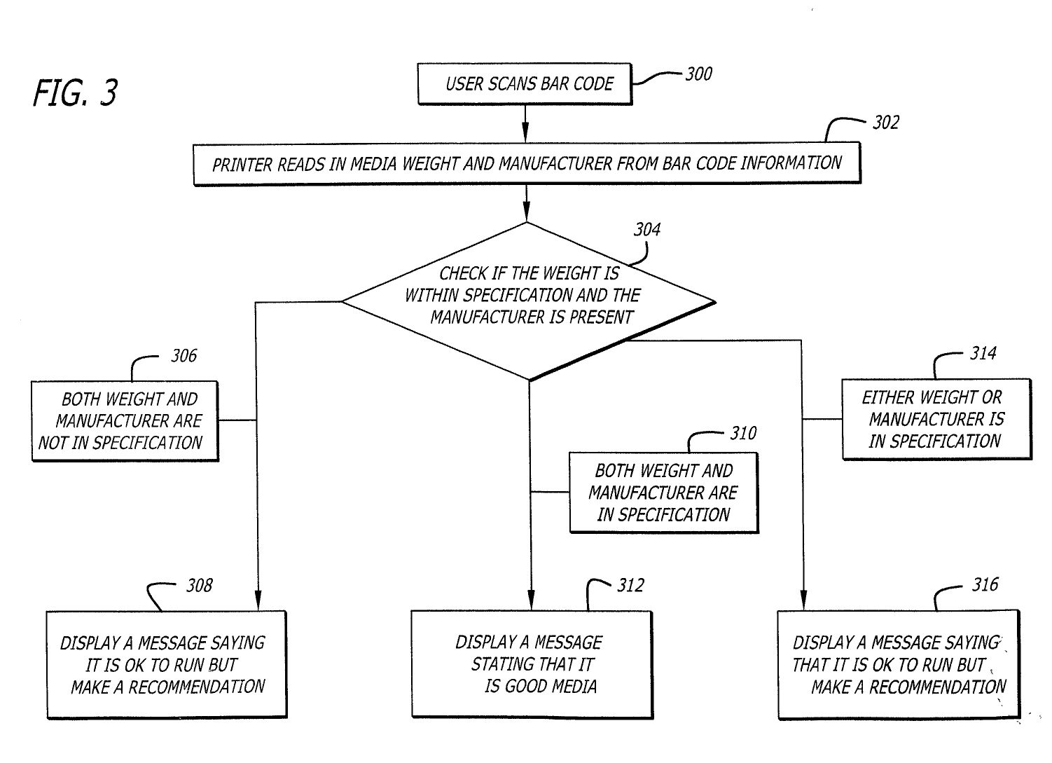

FIG. 3 displays a flow chart of an implementation of the method associated with the present invention. In FIG. 3 an operator would scan the bar code on the media wrapper as shown at 300. The printer would read the bar code as shown at 302 and separate the media weight and the manufacturer from the barcode. At 304, a check is then made of a database stored in the printer to determine if the manufacturer of the media is stored in the database and further, if the media weight is one of the media weights stored in the database. If neither the media weight or the manufacturer are in the database as shown at 308, then a message may be displayed in the printer window which states that the printer can use the media, but a recommendation of a appropriate media may also be displayed. If both the media weight and the manufacturer are in the database as shown at 310, then a message stating that the media is suitable may be displayed in the printer window as shown at 312. The optimum printer settings may also be displayed. If either the media weight or the manufacturer are in the database as shown at 314, then a message stating that the printer can use the media may be displayed in the printer window and a recommendation of a more appropriate media may also be displayed as shown at 316.

FIG. 4 displays a sample table, depicting the printer characteristics stored in the database used in the present invention. The database may include a number of fields and the associated settings for the fields. For example the database may include a barcode field 402. The barcode field typically will be represented as a number such as 32324243 as shown by item 402. A manufacturer field 404 may include manufacturer data such as HP to signify a media/paper manufactured by Hewlett Packard. A weight field 406 may include weight information such as 135 gsm, a typical weight for printing paper. Smoothness field 408 may include a designation of the finish of the paper such as ‘sm’ for smooth or ‘rg’ for rough finish. A stiffness column 410 may also be included with a designation of ‘St’ for stiff. A surface finish field 412 may include surface finish information such as ‘Sf’ for the surface finish. A fuser setting field 414 may include a fuser setting such as high. A transfer voltage setting 416 may include a designation of transfer voltage in volts. Lastly, a speed setting may include a designation such as ‘half-speed’ to indicate the optimum speed at which the media should be processed through the printer.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system comprising:
first means for automatically receiving media related information and
second means responsive to the media related information for configuring a machine in response to the media related information.

2. A printer system comprising:
first means for receiving a media type;
second means responsive to the media type for providing configuration information; and
third means for adjusting the printer in response to the configuration information.

3. A method comprising the steps of:
receiving media type information;
displaying operator information in response to the media type information; and
adjusting the printer in response to the operator information.

4. A printing method including the steps of:
receiving media type information;
accessing configuration information in response to the media type information; and
adjusting the printer in response to the configuration information.

5. A method of operating a printer comprising the steps of:
scanning a bar code, the bar code including first information and second information;
checking a database for the first information and the second information thereby generating checked information;
if neither the first information or second information are in the database, displaying a first message in response to the checked information;
if both the first information and second information are in the database, displaying a second message in response to the checked information; and
if either the first information or the second information are in the database, displaying a third message in response to the checked information.
